(19) United States
(12) Patent Application Publication
(10) Pub. No.: US 2018/0319681 A1
(43) Pub. Date: Nov. 8, 2018

(54) Contactless Ion Concentration Method & Apparatus Using Nanoporous Membrane with Applied Potential

(71) Applicant: United States of America as Represented by The Secretary of the Army, Alexandria, VA (US)

(72) Inventors: Kyoo Jo, Champaign, IL (US); Donald M Cropek, Champaign, IL (US); Yin Song, Champaign, IL (US)

(21) Appl. No.: 15/908,606

(22) Filed: Feb. 28, 2018

Related U.S. Application Data
(60) Provisional application No. 62/500,473, filed on May 2, 2017.

(51) Int. Cl. C02F 1/469

(52) U.S. Cl. CPC C02F 1/4698; C02F 2201/46115

(57) ABSTRACT

The current invention is an apparatus for concentrating ions in a water stream and a method for using the apparatus to concentrate ions for detection and/or removal.

The apparatus is comprised of an electrically charged barrier, a distal electrode having an electrical charge with a sign opposite to the electrical charge of the barrier, and a proximate electrode having an electrical charge with a sign corresponding to the electrical charge of the barrier. The apparatus further includes a moving water stream which is processed to comprise an ion-depleted stream and an ion-concentrated stream located between the distal electrode and the first surface, a first diversion structure to divert the ion-concentrated stream, a second diversion structure to divert the ion-depleted stream, and an electrical power source operatively coupled with the distal and proximate electrodes.

### CROSS-REFERENCE TO RELATED APPLICATIONS

This patent application claims the benefit of U.S. Provisional Application No. 62/500,473 filed May 2, 2017. The above application is incorporated by reference herein.

### STATEMENT REGARDING FEDERALLY SPONSORED RESEARCH OR DEVELOPMENT

The invention described herein was made by an employee of the United States Government and may be manufactured and used by the Government of the United States of America for governmental purposes without the payment of any royalties thereon or therefore.

### FIELD OF INVENTION

This invention relates to the field of water filtration and more specifically to a filtration device that concentrates the location of ions within a water stream.

### BACKGROUND OF THE INVENTION

The U.S. Army Corps of Engineers (USACE) Engineer Research and Development Center (ERDC) has a mission to identify technologies for testing and purification of water.

It is a problem known in the art that the concentration of contaminants in water samples may be too dilute for detection.

It is also a problem known in the art that substantial energy may be required to push water through a filter, and that filters become periodically fouled.

There are needs in the art for testing and filtration processes which can improve the accuracy of detection, prolong the useful life of filtration of devices and conserve energy.

### SUMMARY OF THE INVENTION

The current invention is an apparatus for concentrating ions in a water stream and a method for using the apparatus to concentrate ions for detection and/or removal.

The apparatus is comprised of an electrically charged barrier, a distal electrode having an electrical charge with a sign opposite to the electrical charge of the barrier, and a proximate electrode having an electrical charge with a sign corresponding to the electrical charge of the barrier. The apparatus further includes a moving water stream which is processed to comprise an ion-depleted stream and an ion-concentrated stream located between the distal electrode and the first surface, a first diversion structure to divert the ion-concentrated stream, a second diversion structure to divert the ion-depleted stream, and an electrical power source operatively coupled with the distal and proximate electrodes.

### BRIEF DESCRIPTION OF THE DRAWINGS

FIG. 1a illustrates a schematic of a charged species concentrating apparatus.

FIG. 1b illustrates an exemplary embodiment of a charged species concentrating apparatus.

FIG. 2 illustrates an exemplary method for concentrating charged species.

FIG. 3 illustrates an exemplary large-scale embodiment of a charged species concentrating apparatus using microbeads.

FIG. 4 illustrates exemplary water filtration performance of a charged species concentrating apparatus.

FIG. 5a illustrates an exemplary embodiment of a charged species concentrating apparatus in which the nanoporous membrane has a positive-surface charge.

FIG. 5b illustrates an exemplary embodiment of a charged species concentrating apparatus in which the nanoporous membrane has a negative-surface charge.

FIG. 5c illustrates an exemplary electrophoretic configuration of the apparatus.

### TERMS OF ART

As used herein, the term “barrier” is a structure which repels ions having one charge and allows the passage of ions having an opposite charge, when the structure is electrically charged.

As used herein, the term “distal” means a distance that is farther than a distance referred to as proximate.

As used herein, the term “ion” includes any ion and charged species known in the art, including but not limited to viruses, bacteria, protozoa, spores, clay, hair, proteins, nucleic acids, peptides, lipids, humic acids, chemicals, ions, analytes, and nanoparticles.

As used herein, the term “ion-depleted” means a zone in which the concentration of ions has been reduced by a contactless ion concentration method and apparatus using a nanoporous membrane with applied potential.

As used herein, the term “proximate” means a distance that is closer than a distance referred to as distal.

As used herein, the term “rejection ratio” means a percentage that indicates the efficiency of the apparatus, calculated by multiplying 100 by (1 minus (the concentration of ions in the ion-depleted stream, divided by the concentration of ions in the incoming moving water stream)).

### DETAILED DESCRIPTION OF THE INVENTION

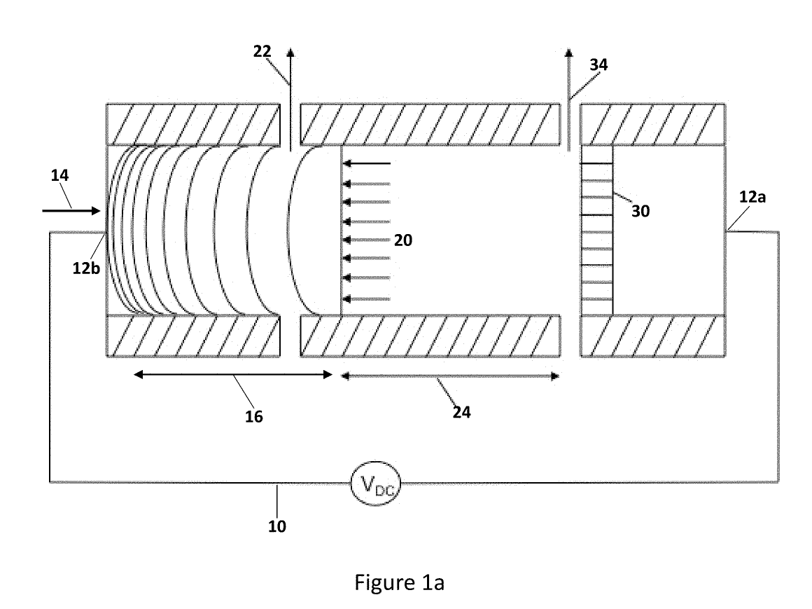

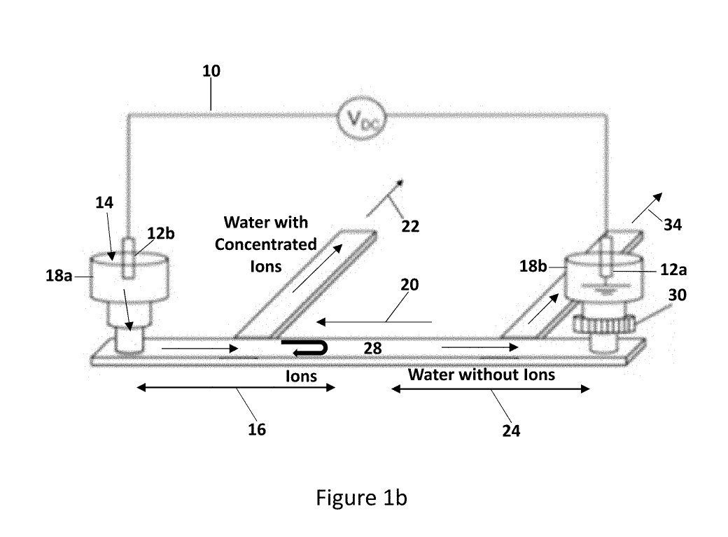

FIG. 1a illustrates a schematic of charged species concentrating apparatus 100 which includes electric circuit 10, proximate electrode 12a, distal electrode 12b, incoming liquid stream 14, ion concentration area 16, electric field 20, ion-concentrated stream 22, ion repellent area 24, membrane 30, and ion-depleted stream 34.

In the exemplary embodiment shown, incoming liquid stream 14 enters apparatus 100, electric circuit 10 is comprised of proximate electrode 12a, and distal electrode 12b and a quantity of liquid that contacts both electrodes. Membrane 30 separates liquid contacted by proximate electrode 12a from liquid contacted by distal electrode 12b. Membrane 30 is an electrically charged barrier. Membrane 30 has an electrically charged surface (positively or negatively charged) and prevents the passage of charged species with a charge sign (polarity) that is the same as the charge on the surface of membrane 30.

Applying an electric potential (i.e. voltage) to electric circuit 10 creates electric field 20. In the exemplary embodiment shown, the electric potential is approximately 50-300 V. The concentration polarization produces a very strong electric field gradient that is localized immediately in front of membrane 30 and repels charged species and other charged impurities from the surface of membrane 30 to create ion repellent area 24.

In the exemplary embodiment shown, electric field 20 stabilizes ion repellent area 24 in front of the nanoporous filter, increasing the water production rate for the nanoporous filter by 3 orders of magnitude (i.e. multiplying the water production rate by a factor of 1000).

The combination of electric field 20 and membrane 30 cause concentration polarization, meaning that charged species contained in incoming liquid stream 14 will move out of ion repellent area 24 to occupy ion concentration area 16.

Ion repellent area 24 abuts membrane 30. This prevents electrically charged species (including bacteria) from physically contacting membrane 30. This “contactless” filtration function prevents bacterial biofilm formation on membrane 30 and clogging or fouling of membrane 30, substantially reducing the need for replacing or cleaning membrane 30, and minimizing maintenance requirements for apparatus 100.

The repelled charged species exit apparatus 100 from ion concentration area 16 in ion-concentrated stream 22, outside of electric field 20. Ion-concentrated stream 22 is up to 3500× more concentrated than incoming liquid stream 14, which facilitates detection and analysis of said species contained within incoming liquid stream 14. Therefore, apparatus 100 may be used as concentrator and separation tool at the same time.

Ion-depleted stream 34 exits apparatus 100 from ion repellent area 24 through electric field 20, and ion-depleted stream 34 is up to 3500× less concentrated than incoming liquid stream 14. Ion-depleted stream 34 does not need to pass through membrane 30, which reduces the energy requirements of charged species concentrating apparatus 100.

In various embodiments, sensors measure the ion concentration of input liquid stream 14 and of ion-depleted stream 34 in order to calculate the rejection ratio of apparatus 100 (1−ion-depleted/input). Sensors may detect the conductivity, fluorescence, absorbance, or other measurable characteristics of liquid streams that indicate the concentration of ions in the liquid.

In various embodiments of the invention, ion concentration area 16 is created before apparatus 100 receives incoming liquid stream 14, to prevent any charged species from physically contacting membrane 30 and fouling it. In these embodiments, apparatus 100 receives a buffer solution. The buffer solution contains ions to make it conductive and contacts both electrodes 12a and 12b to complete electric circuit 10. The ions in the buffer solution will not stick to membrane 30, which eliminates membrane fouling.

Then, electric potential is applied to electric circuit 10, before apparatus 100 receives incoming liquid stream 14. As a consequence of these preparatory steps, the ion concentration 16 and ion repellent zones 24 are established before receiving incoming liquid stream 14.

If no buffer solution is used and/or the charge is not applied prior to the introduction of contaminated fluid into apparatus 100, charged species may reach the surface of membrane 30. This migration could cause fouling of membrane 30, thus the charging of apparatus 100 with a buffer solution and then subsequently applying electric potential to electric circuit 10, before apparatus 100 receives incoming liquid stream 14.

In various embodiments, any salt solution may be used as a buffer in an aqueous system, in the exemplary embodiment shown, the buffer solution is a sodium phosphate solution at pH 7. The methods and apparatus of the invention are not necessarily sensitive to pH.

In various embodiments, membrane 30 may be negatively charged or positively charged. Regardless of the type of membrane (positive or negative pores), the same buffer solution may be used.

In various embodiments, depending on the buffer concentration, electric double layer overlap inside the nanopores results in permselective transport, which is important to the contactless filtration process. In various embodiments, 10 nm sized nanopores provide permselectivity when employing a buffer concentration ranging from 0.1 mM to 10 mM.

In various embodiments, the combination of the charge of membrane 30 and the polarity of electric circuit 10 will determine whether the electroosmotic force or the electrophoretic force dominates apparatus 100. When membrane 30 and proximate electrode 12a have charges that are the same sign, the electroosmotic force dominates and creates an ion repellent area 24 that is large enough to facilitate the exit of ion-depleted stream 34 from apparatus 100. For example, if the surface of membrane 30 is positively charged, the electroosmotic force will dominate if proximate electrode 12a is positively charged and distal electrode 12b is negatively charged. If the surface of membrane 30 is negatively charged, the electroosmotic force will dominate if proximate electrode 12a is negatively charged and distal electrode 12b is positively charged.

In one exemplary embodiment, membrane 30 is a custom nanoceramic disc membrane made of anodic aluminum oxide with a pore size of 13 nm in diameter. This permselective ion barrier disc membrane thickness is 52 μm and the disc diameter is 13 mm.

In another exemplary embodiment, membrane 30 is a polycarbonate membrane with a pore size of 10 nm in diameter. This permselective ion barrier disc membrane thickness is 6 μm and the disc diameter is 13 mm.

In alternative embodiments, any substrate with a high density of nanometer diameter pores may serve as membrane 30. Disk thickness of membrane 30 is only important for physical strength and disc diameter is only important relative to the size of the apparatus in which it is placed.

Generally, any nanoporous membrane may serve as membrane 30, and the following referenced ceramic and polymeric examples are merely representative of the types which may be used. While not intended to be limiting, the definition of nanoporous membranes are a nanostructured track-etched material containing a high density of relatively uniform cylindrical pores that are aligned substantially perpendicular to the surface of the materials and penetrate its entire thickness. The pore diameter is generally 100 nm or less, in certain embodiments 75 nm or less, in certain embodiments 50 nm or less, in certain embodiments 25 nm or less, and in certain embodiments 10 nm or less.

In various embodiments, nanoporous membrane 30 is not used as a physical barrier to remove contaminants based on size; therefore, apparatus 100 can remove a broader range of charged species from water and apparatus 100 does not have the same power and pressure requirements as traditional filtration methods. Furthermore, the power consumed by electric field 20 is relatively small so energy consumption by apparatus 100 is minimized.

In various embodiments, apparatus 100 is powered by a solar cell. In one exemplary embodiment, the solar cell is 100 volts. In various embodiments, the solar cell may have higher or lower voltage. In other embodiments, multiple solar cells or other energy capture devices may be used to power apparatus 100. In various embodiments, apparatus 100 may be a self-contained, portable device.

In various embodiments, apparatus 100 is energy efficient with power consumption values of less than 5 Watt-hours per Liter (Wh/L) with maximum water production rates of ˜50-mL/min. Parallel units of apparatus 100 can reach water production rates in excess of 1-gal/min. A scaled-up microfluidic system can reach water outputs of about 1 gpm (gallon per minute).

Most particles and molecules in liquid that need to be analyzed or removed are charged species such as viruses, bacteria, protozoa, spores, clay, hair, proteins, nucleic acids, peptides, lipids and humic acids.

In various embodiments, if any neutral (uncharged) organic compounds are present in the liquid to be processed, adding charged sorbents including clay, carbon, or zeolite particles to incoming liquid stream 14 allows apparatus 100 to process any neutral (uncharged) organic compounds. The charged sorbents adsorb or bind to neutral organic compounds and then apparatus 100 can repel the charged sorbent (which is a charged species) while it is attached to the neutral organic compound.

In various embodiments of the invention, a second electric potential is applied across ion-concentrated stream 22 (normal/perpendicular to the electric potential across the membrane which creates the concentration polarization). In various embodiments of the invention, this can control and/or increase the rate of removal of the charged species through ion-concentrated stream 22.

In various embodiments, apparatus 100 may be operated in batch mode where incoming liquid stream 14 is not continuous, or continuous mode where incoming liquid stream 14 is continuous.

The invention may be used in series, increasing purification at the output of each stage. For example, in an instance wherein 75% rejection of impurities has been achieved, a second polishing stage may further reduce the impurities so that overall purification of about 93% to 94% can be achieved in two stages. Higher purifications may be achieved in alternative embodiments of the invention.

Separation/concentration of any charged species is possible with both positively and negatively charged membranes.

In various embodiments, apparatus 100 may process organic solvents (i.e. non-aqueous solutions, solutions that are not water-based) with alternative components.

FIG. 1b illustrates an exemplary embodiment of charged species concentrating apparatus 100 which includes electric circuit 10, negative electrode 12a, positive electrode 12b, input water stream 14, ion concentration area 16, reservoirs 18a and 18b, electric field 20, ion-concentrated stream 22, ion repellent area 24, main channel 28, negatively charged membrane 30, and ion-depleted stream 34.

Reservoirs 18a and 18b and main channel 28 all contain a continuous quantity of conductive liquid that contacts electrode 12a or electrode 12b to complete electric circuit 10. Membrane 30 separates the liquid contact point of electrode 12a from the liquid contact point of electrode 12b.

In the exemplary embodiment shown, main channel 28 dimensions are 5 cm in length, 40 μm in height, and 500 μm in width. In various embodiments, increasing the width (e.g. bore) of the main channel can increase the throughput of water and production rate of clean water.

In the exemplary embodiment shown, the side channels for ion-concentrated stream 22 and ion-depleted stream 34 are 2 cm in length and can include a variable width in the range of 50 to 500 μm, and they are perpendicular to the main channel. The height of all the channels in the exemplary embodiment shown is 40 μm. In the exemplary embodiment shown, all channels are made from polydimethylsiloxane (PDMS), but these channels can be constructed from any material that has a negative charge when in contact with water.

In the exemplary embodiment shown, straight arrows on the channels indicate the movement of water. The straight arrow on the side channel containing ion-concentrated stream 22 indicates the movement of water and ions. The curved arrow on main channel 28 indicates the movement of ions repelled by ion repellent area 24. Ion-concentrated stream 22 and ion-depleted stream 34 may be separately collected for sample analysis or clean water collection, respectively.

In various embodiments, the rejection ratio (a performance indicator) of apparatus 100 can be continuously monitored. If the performance of apparatus 100 declines, this may indicate that a particle is lodged in main channel 28 or side channels containing ion-concentrated stream 22 and ion-depleted stream 34. These channels may be backflushed to expel any lodged particles and restore the performance of apparatus 100. If any bacterial biofilm forms in apparatus 100, cleaning solution may be introduced in side channel 34 and directed through main chamber 28 and side channel 22.

In the exemplary embodiment shown, apparatus 100 conducts contactless filtration, as demonstrated by the movement of fluorescein dye within the system while applying 100 Volts through electric circuit 10. (Provisional Application No. 62/500,473; Page 7).

In various embodiments, apparatus 100 may include more than one electric circuit 10. A second electric circuit can apply voltage along ion-concentrated stream 22 to accelerate the exit rate of charged species in the stream, which may allow an increase in the flow rate of the input water stream 14 and the subsequent increase in flow rates of ion-concentrated stream 22 and ion-depleted stream 34.

In various embodiments, apparatus 100 includes hydrodynamic pumping to initiate and maintain the flow of input water stream 14. Hydrodynamic pumping requires that the water level in reservoir 18a (which receives input water stream 14) is higher than the water level in reservoir 18b, which may require that reservoir 18a is significantly taller than reservoir 18b.

In various embodiments, multiple apparatuses 100 may be connected in series. For example, ion-depleted stream 34 from a first apparatus 100 can be directed into input water stream 14 for a second apparatus 100, and ion-depleted stream 34 from a second apparatus 100 can be directed into input water stream 14 for a third apparatus 100. This connection pattern may continue for multiple apparatuses 100.

In various embodiments, apparatus 100 includes sub-structures in main channel 28 that stabilize ion repellent area 24 and provide a means to scale the system up (e.g. increase clean water production rates). In various embodiments, the substructures create multiple microfluidic subchannels in main channel 28. Having multiple microfluidic subchannels allows an increase in the cross-sectional area of main channel 28 to increase the flow rate of input water stream 14. In various embodiments, polydimethylsiloxane (PDMS) microbeads, which vary from 100-300 μm in diameter are used as a neutral structure and the spacing between adjacent microbeads creates a pathway, which behaves like a microfluidic channel.

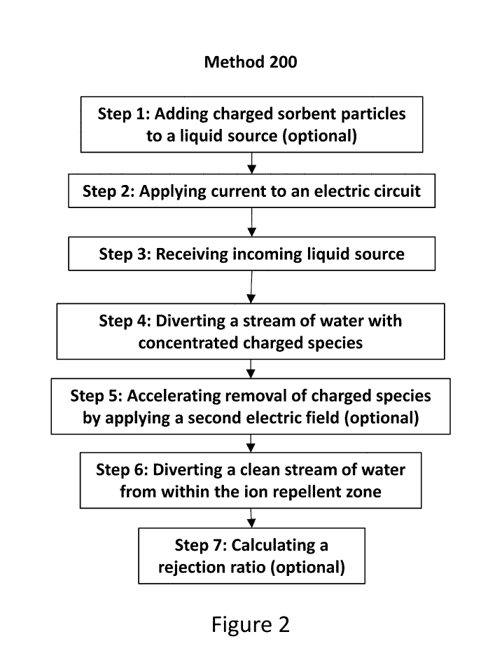

FIG. 2 illustrates exemplary ion concentration method 200. Method 200 is a method for concentrating charged species within a liquid source to facilitate their detection and/or removal.

Step 1 is the optional step of adding charged sorbent particles to an incoming liquid source before apparatus 100 processes it.

If the liquid source contains species that are electrically neutral (i.e. uncharged), the charged sorbent particles can bind to the neutral organic particles and apparatus 100 can process the neutral organic particles while they are bound to the charged sorbent particles.

Step 2 is the step of applying an electric current to a circuit to establish the concentration polarization and concentrate ions in one zone of the main channel.

The circuit incorporates a membrane and it achieves concentration polarization through electroosmosis, creating an ion concentration zone distal from the membrane and an ion repellent zone proximate to the membrane.

To be complete, the circuit in apparatus 100 requires a conductive liquid. The conductive liquid may be a salt buffer.

Step 3 is the step of receiving a flow of a liquid source containing charged species.

In the exemplary embodiment shown, a liquid source with charged species enters apparatus 100.

Step 4 is the step of diverting a stream of liquid that includes concentrated charged species.

A stream of liquid is diverted from the ion concentration area in apparatus 100 and contains a high concentration of charged species. This stream of liquid is called the ion-concentrated stream.

Step 5 is the optional step of accelerating the exit of charged species from apparatus 100 in the ion-concentrated stream.

Step 5 can be accomplished by applying a second electric field to the ion-concentrated stream.

Step 6 is the step of diverting an ion-depleted stream from within the ion repellent zone.

This step does not direct water through the nanoporous membrane, which reduces the energy requirements of apparatus 100 compared to those of traditional filters.

Step 7 is the optional step of calculating the rejection ratio of apparatus 100.

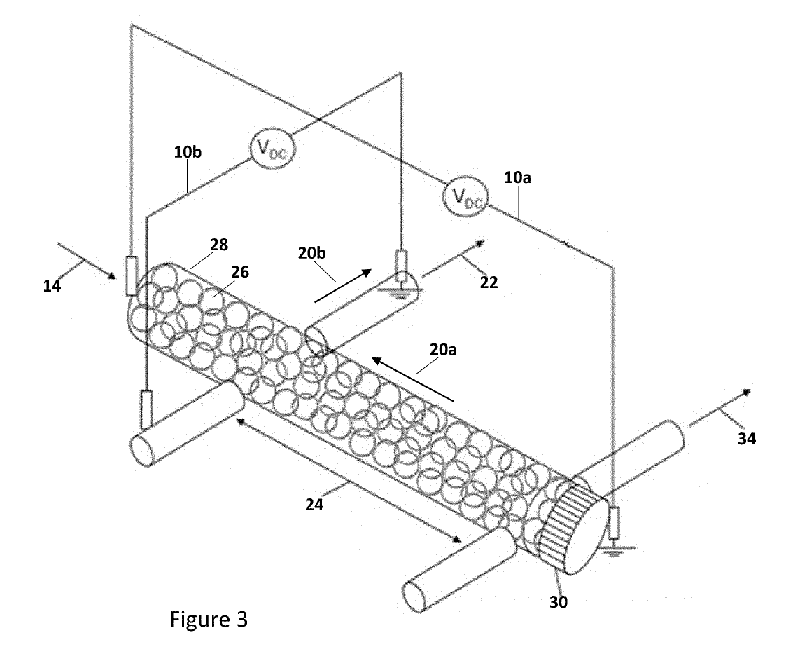

FIG. 3 illustrates a scaled-up embodiment of charged species concentrating apparatus 100 using microbeads.

Visible in FIG. 3 are electric circuits 10a and 10b, input water stream 12, electric fields 20a and 20b, ion-concentrated stream 22, ion repellent zone 24, microbeads 26, chamber 28, membrane 30, ion-depleted stream 34.

In the exemplary embodiment shown, electric circuit 10b accelerates the rate by which charged species exit apparatus 100 through ion-concentrated stream 22.

Microbeads 26 in mesoscale (i.e. medium-sized) apparatus 100 create a microfluidic environment in macro-fluidic chamber 28 and stabilize the ion concentration and ion repellent zones. The macrosized chamber allows increased flow rate through the device and a higher rate of clean water production.

In the exemplary embodiment shown, the diameter of microbeads 26 is approximately 100-300 μm and chamber 28 is approximately 5-10 cm in diameter and 25 cm-2 feet long.

In the exemplary embodiment shown, the filtration mode is an electroosmotic flow (EOF) dominant process, which can be described in terms of velocity or mobility. Initial studies indicated that the EOF was decreased in the microfluidic channel made of negatively charged polydimethylsiloxane (PDMS), as we increased the operation voltage. To eliminate this EOF effect, a non-charged polymer coating may be grafted onto the PDMS surface.

In the exemplary embodiment shown, the fast and selective removal of impurities is enhanced by application of high voltage of approximately 50-300V to circuit 10b, between the removal channels, along with a hydrodynamic pumping method.

In the exemplary embodiment shown, input water stream 14 enters apparatus 100 through a channel with an inside diameter (I.D.) of 0.01-0.5 cm.

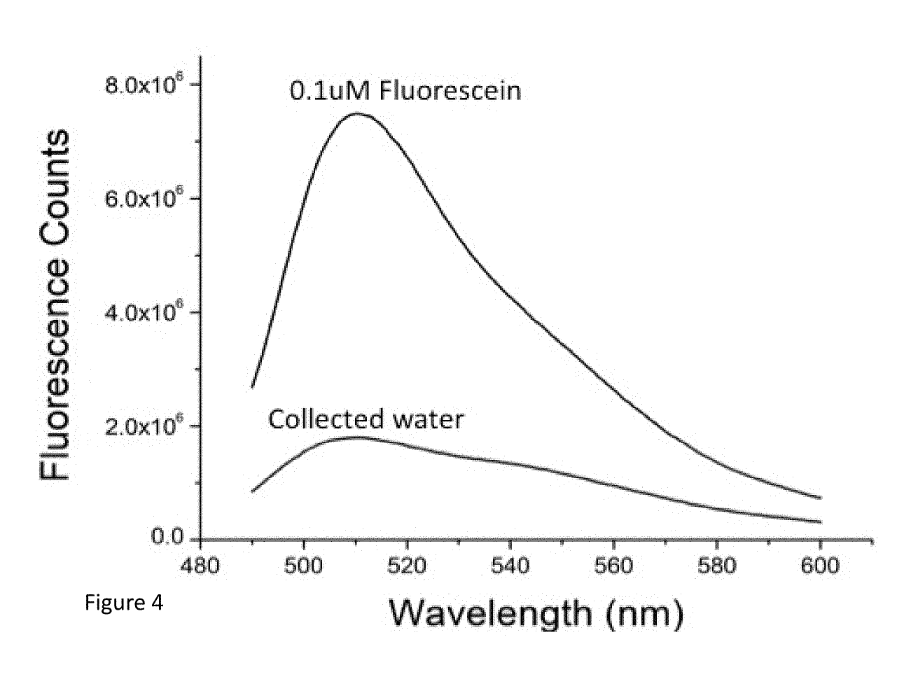

FIG. 4 illustrates exemplary water filtration performance of charged species concentrating apparatus 100.

Visible in FIG. 4 are exemplary filtration results observed after apparatus 100 received a water-based buffer solution containing 0.10 fluorescein at a constant flow rate of 204/min.

A fluorimeter measured the fluorescein concentration of the input water stream and the collected clean water that was filtered by contactless filtration. Phosphate-buffered saline (PBS) without any fluorescein was used as standard solution to calibrate and normalize the spectral data. Upon comparison, the maximum fluorescence intensity of collected clean water decreased by approximately 76% from the fluorescence intensity of the input sample after the filtration process for 0.1 μM fluorescein.

Extrapolating from these data, over 99% of impurities can be removed/concentrated/filtered by processing water through four apparatus 100 units in series.

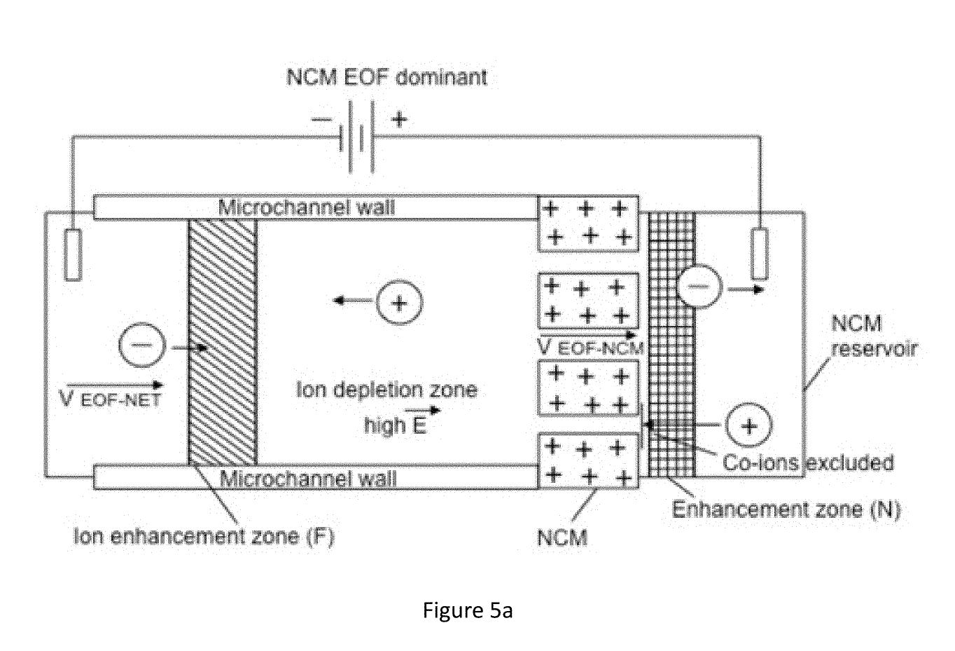

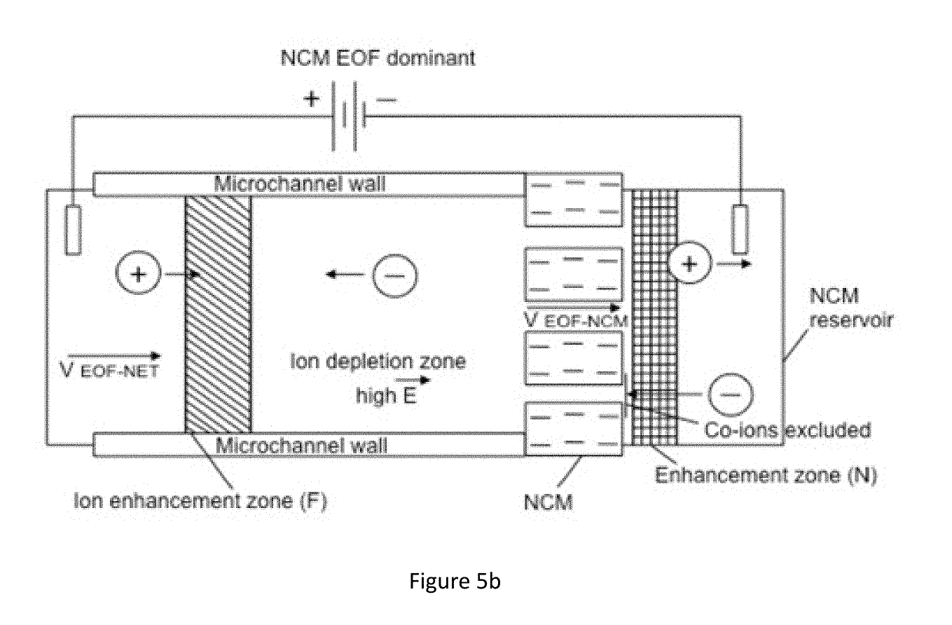

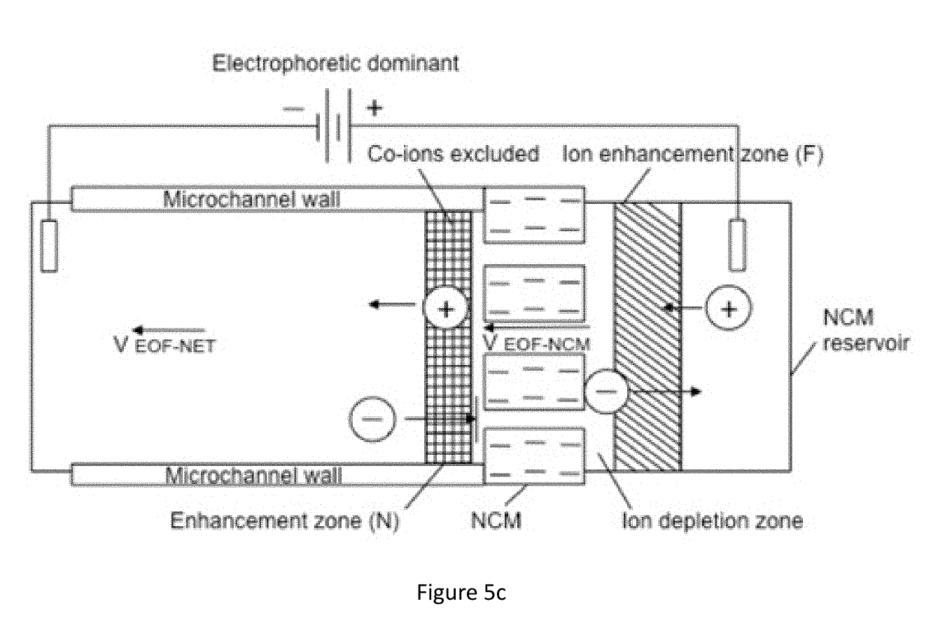

FIG. 5a illustrates an exemplary embodiment of charged species concentrating apparatus 100 with a positively charged selective ion barrier.

In the exemplary embodiment shown, a nanoporous membrane separates the liquid contacted by each electrode (one negative and one positive) of the main electric circuit. The combination of the charge of the nanoporous membrane and the placement and polarity of the electric circuit's electrodes will determine whether the electroosmotic force or the electrophoretic force dominates the system.

To create an ion depletion (repellent) zone that is large enough to allow an exit point for the ion-depleted stream, the electroosmotic force must dominate. In the exemplary embodiment shown, the nanoporous membrane is positively charged and will selectively block positively charged ions (cations). For the electroosmotic force to dominate when the nanoporous membrane is positively charged, the positively charged electrode is placed proximate to one side of the nanoporous membrane and the negatively charged electrode is placed more distal to the opposite side of the nanoporous membrane.

FIG. 5b illustrates an exemplary embodiment of charged species concentrating apparatus 100 with a negatively charged nanoporous membrane.

To create an ion depletion zone that is large enough to allow an exit point for the ion-depleted stream, the electroosmotic force must dominate. In the exemplary embodiment shown, the nanoporous membrane is negatively charged and will selectively block negatively charged ions (anions). For the electroosmotic force to dominate when the nanoporous membrane is negatively charged, the negatively charged electrode is placed proximate to one side of the nanoporous membrane and the positively charged electrode is placed more distal to the opposite side of the nanoporous membrane.

Our nanofluidic/microfluidic interface (NMI) concentrators induce ion concentration polarization (CP) that produces zones of ion enrichment and ion depletion in the microfluidic channel (FIGS. 5a-c).

The pore interiors of the nanocapillary membrane (NCM) (i.e. nanoporous membrane) that serves as the permselective ion barrier in the exemplary embodiment shown are also ion depleted, and this depletion prevents passage through the nanocapillaries of the NCM. The depleted and enriched zones form transient localized regions of high and low electric field strengths, respectively.

The nanochannels and nanocapillaries that are used in nanofluidic/microfluidic interface (NMI) concentrators are ion permselective. By definition, ion permselective materials, or selective ion barriers, selectively interfere with the transport of either anions (negatively charged species) or cations (positively charged species).

Permselectivity is a direct result of charge repulsion between the surface charge of the ion barrier and co-ions (ions with the same polarity, or sign, of charge) in solution. A nanochannel exhibits permselectivity when the thickness of the diffuse or double layer is comparable to or greater than the radius of the nanochannel. Under these conditions, double layer overlap exists and the surface charge is not fully compensated, causing charge repulsion of co-ions in solution.

The selective ion transport through a permselective material produces concentration polarization of current-carrying ions. The reduced passage of co-ions through the NCM causes increased concentration of co-ions in front of the NCM and a concomitant increase in counter-ion concentration to maintain charge neutrality. An ion depletion zone forms on the side of the membrane on which co-ions are driven away from the membrane by the applied potential. Since the transport of co-ions through the membrane is negligible, the membrane prevents the replenishment of this depletion zone.

In the meantime, counter-ions (ions with a charge polarity, or sign, that is opposite the charge of the selective ion barrier) in this region are driven toward the ion enhancement zones (F and N) to maintain charge neutrality. Thus, concentration polarization is characterized by non-uniform spatial distribution of the ions. The NCM is permselective due to double layer overlap in the nanochannels. When double layer overlap exists, the surface charge on the nanocapillary walls is not fully compensated, leading to charge exclusion of the co-ions.

Permselectivity of the NCM and ion migration under the applied potential create a region of ion depletion around the NCM. The side of the NCM on which the ion depletion zone forms is determined by the polarity of the applied voltage and the NCM surface charge. Regions of enhanced concentration form on both sides of the ion depletion zone; one near (N) the NCM, and one that extends far (F) from the NCM.

Charge neutrality is maintained in the enhancement zones and the bulk ion depletion zone, but not in the nanocapillaries. The concentration enhancement observed in zone F is greater than the enhancement observed in zone N. In this model, the electroosmotic flow (EOF) in the nanochannels is assumed to dominate the net EOF of the system (V_{EOF-NET}=V_{EOF-NCM}), while the contribution of the microchannel EOF to the net EOF is negligible. In FIGS. 5a and 5b, the depletion zone forms in the microfluidic channel on the sample inlet side, creating an intense enhancement zone in the microfluidic channel.

It is important to note that in FIGS. 5a and 5b, transport of charged species to the enhancement zone is dependent on the EOF of the NCM, where the magnitude of EOF and electrophoretic mobility of counter-ions (and co-ions) are balanced in the microfluidic channel. As always, both anions and cations are concentrated in the enhancement zone to maintain charge neutrality.

The exemplary embodiments shown in FIGS. 5a and 5b are very similar, but in 5a the surface of the NCM is positively charged. Analogous to FIG. 5b, EOF of the NCM dominates and carries both anions and cations to the enhancement zone F.

FIG. 5c illustrates an exemplary electrophoretic configuration of apparatus 100. This figure demonstrates how the electrophoretic force creates an ion depletion zone that is very small and very close to the NCM, which does not facilitate the exit of an ion-depleted water stream from the apparatus.

In the exemplary embodiment shown, a nanoporous membrane separates the liquid contacted by each electrode (one negative and one positive) of the main electric circuit. The combination of the charge of the nanoporous membrane and the placement and polarity of the electric circuit's electrodes will determine whether the electroosmotic force or the electrophoretic force dominates the system. To create an ion depletion zone that is large enough to allow an exit point for the ion-depleted stream, the electroosmotic force must dominate.

In the exemplary embodiment shown, the nanoporous membrane is negatively charged and will selectively block negatively charged ions (anions). The positively charged electrode is placed proximate to one side of the nanoporous membrane and the negatively charged electrode is placed more distal to the opposite side of the nanoporous membrane, which allows the electrophoretic force to dominate the system and causes the formation of a small ion depletion zone.

In FIG. 5c, transport of species to the NCM relies on low NCM EOF so the anion's electrophoretic mobility is dominant. If the NCM reservoir is substantially larger than the cross-sectional dimension of the microfluidic channel, convective mixing in the macroscale reservoir leads to a decrease in the concentration polarization, diminishing the concentration enhancement in the microchannel.

In embodiments of the invention and the claims appended hereto, the terms “ions”, “charged particles”, and “charged species” may be used interchangeably. In the context of this application, these terms are meant to encompass not only molecules and ions, but any larger “charged particles” or “charged species” having a broader size range.

In various embodiments, apparatus 100 may be used for humanitarian purposes or in the field by soldiers or first responders.

In various embodiments, apparatus 100 may be used for water desalination or purification. For example, apparatus 100 may be used as portable water filtration and purification units for houses, hospitals and remote vehicles.

In various embodiments, apparatus 100 may be used for analyte/contaminant concentration, or analyte sensing. For example, apparatus 100 may be used for concentration and sensing of harmful and/or useful chemicals/biochemicals in aqueous based solutions.

What is claimed is:

1. A filtration apparatus comprised of:
an electrically charged barrier having a first surface and a second surface;
a distal electrode having an electrical charge with a sign opposite to said electrical charge of said barrier, placed at a first distance from said first surface;
a proximate electrode having an electrical charge with a sign corresponding to said electrical charge of said barrier, placed at a second distance from said second surface;
wherein said second distance is smaller than said first distance;
a moving water stream comprised of an ion-depleted stream and an ion-concentrated stream, located between said distal electrode and said first surface;
a first diversion structure to divert said ion-concentrated stream;
a second diversion structure to divert said ion-depleted stream; and
an electrical power source operatively coupled with said distal electrode and said proximate electrode.

2. The apparatus of claim 1, which further includes a receptacle for storing said ion-concentrated stream.

3. The apparatus of claim 1, which further includes a receptacle for storing said ion-depleted stream.

4. The apparatus of claim 1, wherein said electrical power source is selected from a group consisting of: a solar power collection component, a battery, a kinetically powered component, and a gasoline-powered electrical generator.

5. The apparatus of claim 1, wherein said first diversion structure and said second diversion structure are selected from a group consisting of: a tube, a hole, a channel, and an opening.

6. The apparatus of claim 1, wherein said moving water stream is comprised of a solution containing electrically charged sorbent material.

7. The apparatus of claim 1, wherein said first diversion structure further includes a third electrode and a fourth electrode.

8. The apparatus of claim 1, wherein said moving water stream is operatively coupled with a sensor.

9. The apparatus of claim 1, wherein said ion-depleted stream is operatively coupled with a sensor.

10. The apparatus of claim 1, wherein said ion-concentrated stream is operatively coupled with a sensor.

11. The apparatus of claim 1, wherein said moving water stream is directed through a channel having internal structures that create a plurality of subchannels.

12. The apparatus of claim 11, wherein said internal structures are microbeads.

13. A method for purifying water, comprised of the steps of:
creating an electrically charged barrier having a first surface and a second surface;
placing a distal electrode having an opposite charge to said barrier, at a first distance from said first surface;
placing a proximate electrode having a corresponding charge to said barrier at a second distance from said second surface;
directing a moving water stream through said distal electrode to create an ion-depleted stream and an ion-concentrated stream, located between said distal electrode and said first surface;
diverting said ion-concentrated stream;
diverting said ion-depleted stream; and
collecting said ion-depleted stream.

14. The method of claim 13, which further includes the step of placing a third electrode and a fourth electrode in said ion-concentrated stream to create an electric field.

15. The method of claim 13, which further includes the step of creating a solution by adding an electrically charged sorbent material to said moving water stream.

16. The method of claim 13, which further includes the step of calculating a rejection ratio.

17. A method for obtaining a high concentration species sample, comprised of the steps of:
creating an electrically charged barrier having a first surface and a second surface;
placing a distal electrode having an opposite charge to said barrier, at a first distance from said first surface;
placing a proximate electrode having a corresponding charge to said barrier at a second distance from said second surface;
directing a moving water stream through said distal electrode to create an ion-depleted stream and an ion-concentrated stream, located between said distal electrode and said first surface;
diverting said ion-concentrated stream;
diverting said ion-depleted stream; and
collecting said ion-concentrated stream.

18. The method of claim 17, which further includes the step of placing a third electrode and a fourth electrode in said ion-concentrated stream to create an electric field.

19. The method of claim 17, which further includes the step of creating a solution by adding an electrically charged sorbent material to said moving water stream.

20. The method of claim 17, which further includes the step of calculating a rejection ratio.
